(19) United States
(12) Patent Application Publication
(10) Pub. No.: US 2024/0394757 A1
(43) Pub. Date: Nov. 28, 2024

(54) SYSTEM AND METHOD FOR IMPROVING ACCURACY OF RESIDENTIAL HOME VALUATIONS

(71) Applicant: Thomas Canale, Peoria, AZ (US)

(72) Inventor: Thomas Canale, Peoria, AZ (US)

(21) Appl. No.: 18/652,246

(22) Filed: May 1, 2024

Related U.S. Application Data
(60) Provisional application No. 63/469,129, filed on May 26, 2023.

(51) Int. Cl. G06Q 30/02; G06F 3/0482; G06Q 50/16

(52) U.S. Cl. CPC G06Q 30/0278; G06Q 50/16; G06F 3/0482

(57) ABSTRACT

A method for improving accuracy of valuations of a subject home having a plurality of home features, wherein the subject home is in a home valuation area that is identified by an address. The method can comprise providing a platform comprising at least one user account associated with a user profile of the user. The method can create a list of value features that affect the value of a subject home and then accessing data concerning value features from at least one available database. The application can then identify the subject home based on input from the user and defining a subject home valuation area and then search homes within the subject home valuation area and returning a listing of comparable homes to the subject home based at least in part on the associated value features.

### CROSS REFERENCE

This application claims the benefit from currently U.S. Provisional Application No. 63/469,129 titled “SYSTEM AND METHOD FOR IMPROVING ACCURACY OF RESIDENTIAL HOME VALUATIONS” and having a filing date of May 26, 2023, and all of which is incorporated by reference herein.

### FIELD OF THE INVENTION

The subject application is drawn to a system for agents and/or consumers to use to improve the accuracy of the residential home valuations.

### BACKGROUND OF THE INVENTION

When an individual puts their house up for sell and receive an offer, the banks usually require the house to appraise for at least the sale price of the house or the fair market value of the house. So, an appraiser, which is an unbiased professional, is hired to determine the value of the individual's house. The appraiser assesses many different factors that can affect the home value some of which are the houses overall condition, the location, the size of the home, plumbing and electrical systems, any updates to the home, how much nearby housing as sold for, any damage to the house, and indoor and outdoor amenities. Each of these factors affect the overall value of the home and can either negatively or positively affect the valued price.

To get the above information appraisers will usually cull the multiple listing services (“MLS”) to find the necessary data to evaluate the value of a residential home. This process consists of manually searching the local MLS for similar homes and recent home sales. Once the comparable sales and listings are chosen the data is usually put into a comparative market analysis (“CMA”) tool that estimates the value of the specific property. Another method used by appraisers is the automated valuation methos (“AVM”) which is a fully automated system that uses all the sales data for an area and through mathematical equations the home value in real-time is defined.

Typically, agents and/or consumers do not possess the knowledge to accurately find the data necessary to derive the value for a residential home and currently there is no tool available that can accurately assist the agent in the comparable selection process nor the overall market conditions. Additionally, there are no tools for adjustments nor guidelines on how or when to make adjustments to the comparable sale/listing selected.

Further, an automated system does not consider any features of a property that may be advantageous nor adverse to the value. For example, if one home has a remodeled kitchen and master bathroom and another sale is located in an area that backs up against a major road with no updates to the kitchen nor bathroom these homes would be considered equal in the system which makes current systems unreliable. This type of system will not consistently provide accurate estimates of home values.

Therefore, there is a need for a method and system that improves the accuracy of residential home valuations.

### BRIEF SUMMARY OF THE INVENTION

Accordingly, the present inventions comprise a method for improving accuracy of valuations of a subject home having a plurality of home features, wherein the subject home is in a home valuation area that is identified by an address. The method can comprise providing a platform comprising at least one user account associated with a user profile of the user. Creating a listing of value features that affect the value of a subject home and then accessing data concerning value features from at least one available database. The application can then identify the subject home based on input from the user and defining a subject home valuation area and then search homes within the subject home valuation area and returning a listing of comparable homes to the subject home based at least in part on the associated value features.

Providing a comparable selection guide that allows the user to associate appropriate value features with the comparable homes. The assigning a base value and a value feature value for the subject home and the comparable homes. The method can further comprise adjusting the home valuation area to encompass a desired number of comparable homes and can allow the user to adjust the value feature value of at least one of the subject homes and the comparable homes. The application can access the database to confirm the information from the main database. The value features can be gross living area, lot size, parking, pool, number of bedrooms, number of bathrooms, views, and upgrades done to the comparable home or subject home. The method wherein the value features are adjusted to fit the market, according to the comparable home or subject home. The method can accept or reject the adjustment made to the subject home. The method can generate a report showing the adjusted value of the subject home.

The method can further comprise an administrator interface wherein the administrator interface has an adjustment manager wherein the value features or adjustments are updated based on the market conditions. The administrator can set a lot size adjustment (“LSA”) wherein every subject home and comparable home has a lot size which that can be calculated by length times width of the lot. The adjustment manager allows the administrator to control the value features or adjustment in the comparable homes wherein the adjustments are parking control adjustments, gross living area adjustment, spa and pool adjustments, bedroom adjustments, bathroom adjustment, view adjustment, and upgrades adjustment.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is a method for improving accuracy of valuations of a subject home having a plurality of home features showing an agent's portal in accordance to one, or more embodiments;

FIG. 2 is a method for improving accuracy of valuations of a subject home having a plurality of home features performing a report in accordance to one, or more embodiments;

FIG. 3 is a method for improving accuracy of valuations of a subject home having a plurality of home features showing steps to create a report in accordance to one, or more embodiments;

FIG. 4 is a method for improving accuracy of valuations of a subject home having a plurality of home features showing adjustments made to comparable homes in accordance to one, or more embodiments;

FIG. 5 is the method for improving accuracy of valuations of a subject home having a plurality of home features in accordance showing steps to create a report to one, or more embodiments;

FIG. 6 is the method for improving accuracy of valuations of a subject home having

a plurality of home features showing the administrator's login in accordance to one, or more embodiments;

FIG. 7 is the method for improving accuracy of valuations of a subject home having a plurality of home features showing value features for GLA and lost size in accordance to one, or more embodiments; and

FIG. 8 is the method for improving accuracy of valuations of a subject home having a plurality of home features showing value features for parking and pool and spa in accordance to one, or more embodiments;

FIG. 9 is the method for improving accuracy of valuations of a subject home having a plurality of home features showing value features for bedroom and bathroom adjustments in accordance to one, or more embodiments;

FIG. 10 is the method for improving accuracy of valuations of a subject home having a plurality of home features showing value view adjustments in accordance to one, or more embodiments; and

FIG. 11 is the method for improving accuracy of valuations of a subject home having a plurality of home features showing value features for upgrade adjustments in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

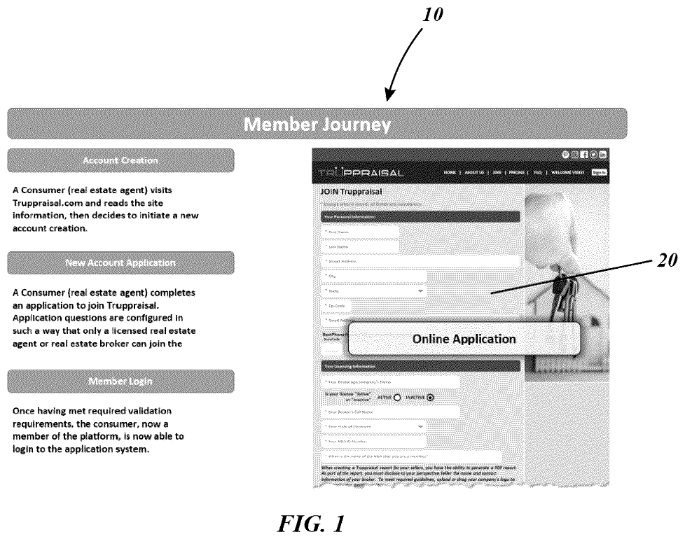

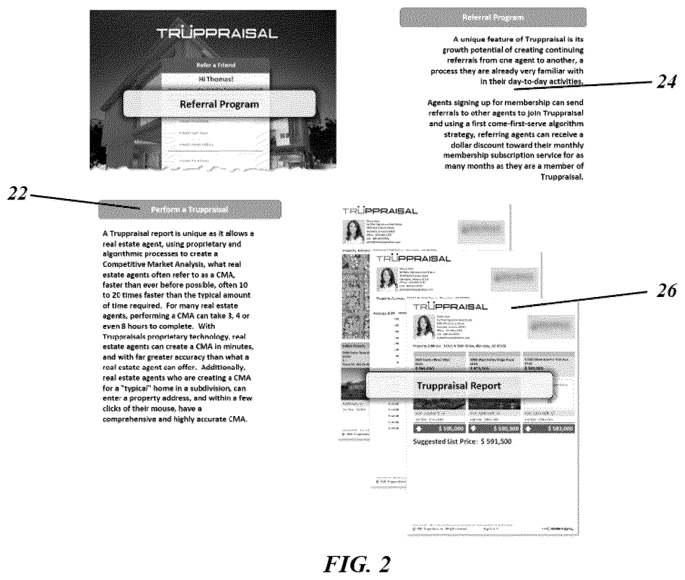

Referring to FIGS. 1 and 2, a method for improving accuracy of valuations of a subject home that is in a subject home valuation area that can be identified by an address for improving the accuracy of home valuations by utilizing a platform that allows users to create a listing of value features that affect the value of a subject home. In embodiments, the application can provide a platform comprising at least one user account associated with a user profile of the user. An agent can sign up for an account, typically through installing an app 10 on a mobile device by inputting the agent's information 12 such as, for example, name, address, phone number, license number for such as, for example, an agent, a real estate broker, or the like. The application can verify the agent's license by such as, for example, the user uploading their license, searching appraiser licensing database, professional appraiser organizations, state's licensing board, online database/registry, or the like.

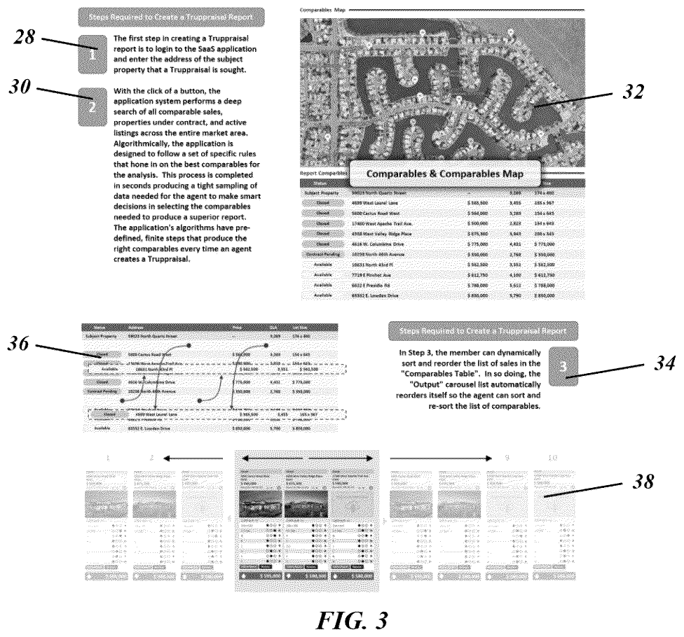

Referring to FIG. 3, at 28 the agent can login into an account and can enter a subject home's address and can identify the subject home based on input from the user and defining a subject home valuation area. The agent can set a distance from the subject home and the application searches at least one database which can be such, for example, Multiple Listing Service (MLS), Google Map, tax database, or the like in the area at a set distance from the subject home. At 30 the user can click a button which performs a database search on MLS, Google Map, tax database, CoreLogic, or the like. After the database search is complete at 32 the application can return a map and a table showing the area surrounding the subject home, the location of at least one of comparable home on the map and at least one of the following such as, for example, status of the comparable homes (closed, available, contract pending), address of the comparable home, price, size of comparable home, lot size, gross living area (“GLA”) or the like. At 36 and 38, the comparable homes can be sorted in order of importance by the user, or the application or the user can drop the closed, pending, or any comparable homes that do not apply to the subject home.

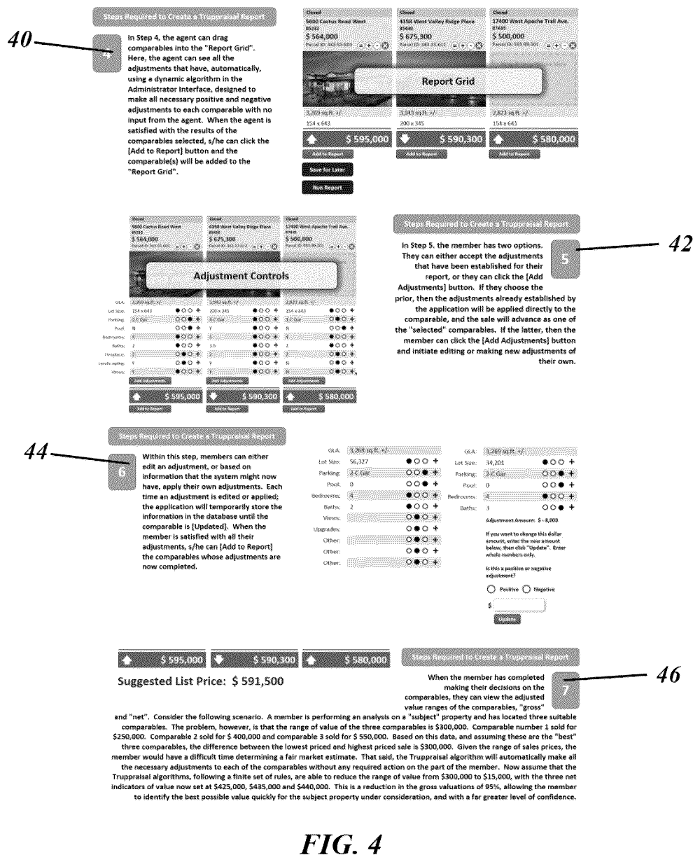

Referring to FIG. 4, at 40 the agent can drag comparable homes into a report grid wherein the application can make a positive or a negative adjustment to each comparable home without any input from the agent. The agent can choose at least one of such as, for example, add to the report, save for later, or the like. At 42 the agent can either accept the adjustments that has been established by the application or the agent can create a list of value features that affect the value of the subject home. The value features can be such as, for example, square footage, lot size, parking, pool and spa, bedroom, bathroom, view, upgrades or the like. At step 44, the agent or the application can create or edit the value features that affect the value of the subject home. Each time a value feature is adjusted or applied the application can store the information until the comparable home is update wherein the agent can add in their own adjustment whether it be positive or negative and can enter a dollar amount. Once the value features have been updated the agent can update the comparable home within the applications and the application can search comparable homes within the subject home valuation area and returning a listing of comparable homes to the subject home based at least in part on the associated value features.

At 46, once the agent has completed making the decisions on the comparable home, the agent can view the adjusted value ranges of the comparables, both gross and net and the application can provide a comparable selection guide that allows the user to associate appropriate value features with the comparable homes. For example, the agent can perform an analysis on the subject home and has located three comparable homes. The range of value of the three comparables is $300,000 wherein comparable home one sold for $250,000, comparable home two has sold for $400,000 and comparable home three has sold for $550,000. The application will analyze the difference between the highest priced comparable home and the lowest home comparable home wherein the application makes the value feature adjustments without any required action by the agent.

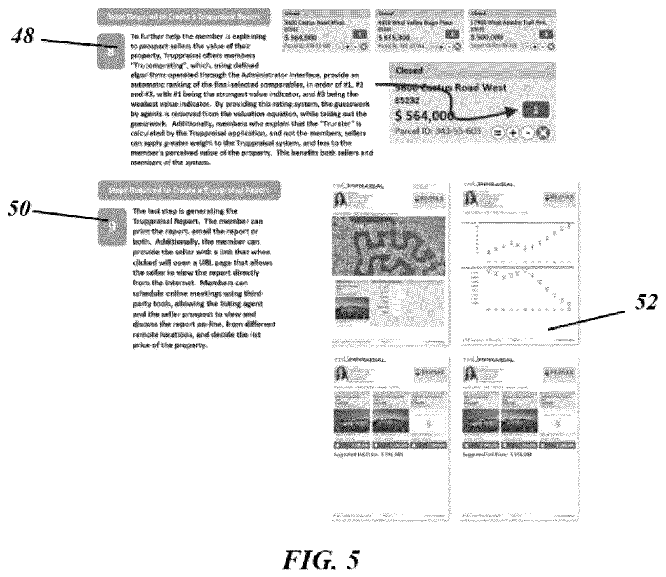

Referring to FIG. 5, at 48 the application can rank the comparable homes in order of strongest value feature to the weakest value feature. At 50, the application can generate a report wherein the agent can email, print or both the report. The report can show such as, for example, the subject home appraisal as a suggest list price, the comparable homes, the value features used or the like. The agent can send the homeowner seller a link that allows the homeowner seller to view the report directly from the internet. The agents and/or consumers can schedule online meetings using third party tool, allowing the homeowner seller prospect to view and discuss the such as, for example, report online, from different remote locations, or the like and can decide the list price of the subject property wherein the application can provide a comparable selection guide that allows the user to associate appropriate value features with the comparable homes setting the price of the subject home.

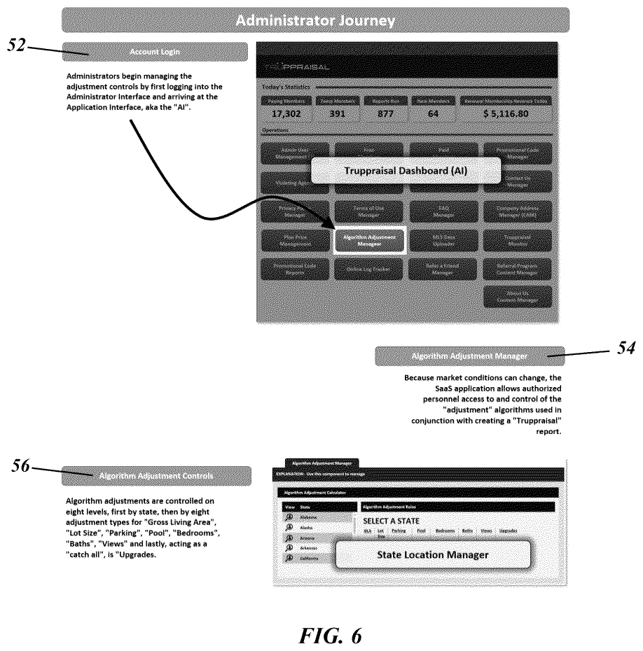

Referring to FIG. 6, at 52, shows the administrator account login wherein the administrator can access the applications account. The administrator interface can comprise such as, for example, paying members, temp members, reports run, new members, renewal membership revenue, or the like and an adjustment manager, at 54, wherein the administrator can change and update the value features because market conditions are in a constant flux due to varying market conditions such as, market trends, government policies and regulations, demographic trends, property characteristics, local market conditions, or the like. At 56, the value features can be referred to as adjustments wherein the adjustment manager can allow the administrator to control the value features or adjustment in the comparable homes for such as, for example, gross living area, lot size, parking, pool, bedrooms, baths, views, upgrades and the like. The administrator can set, choose or can locate the subject home or comparable home in the state it is in. The adjustment manager allows the administrator to control the value features or adjustment in the comparable homes wherein the adjustments can be such as, for example, parking control adjustments, gross living area adjustment, spa and pool adjustments, bedroom adjustments, bathroom adjustment, view adjustment, and upgrades adjustment.

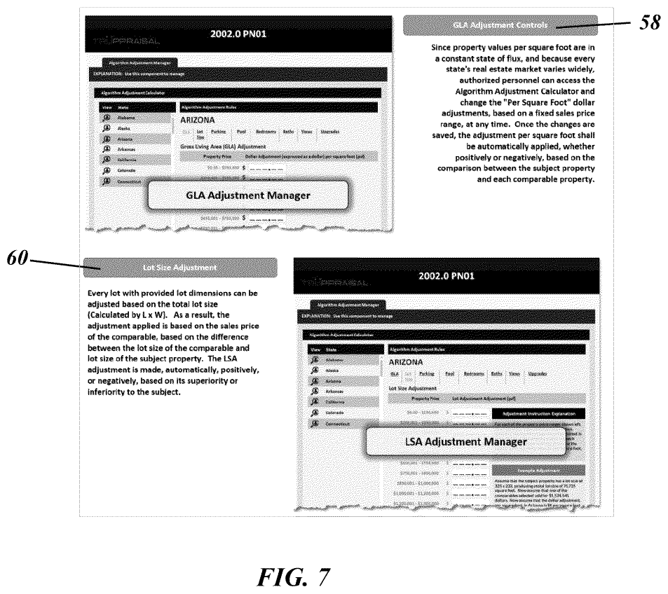

Referring to FIG. 7, at 58 since the housing market is in a constant state of flux such as, the interest rates, the number of houses on the market, and the demand for those houses all effect the price of the subject home. The adjustment calculator can allow the administrator to change the per square foot dollar adjustment according to those housing factors. Once the administrator makes the changes the adjustment per square foot is automatically applied, whether it be positive or negative based on the comparison between the subject home and each comparable home. At 60, the administrator can set a lot size adjustment (“LSA”) wherein every subject home and comparable home has a lot size which is calculated by length times width of the lot. The lot size adjustment can be made by making a comparison between the lot size of the comparable homes and the lot size of the subject home. The LSA can be made either automatically, positively, or negatively based on the superiority of inferiority of the comparable home to the subject home.

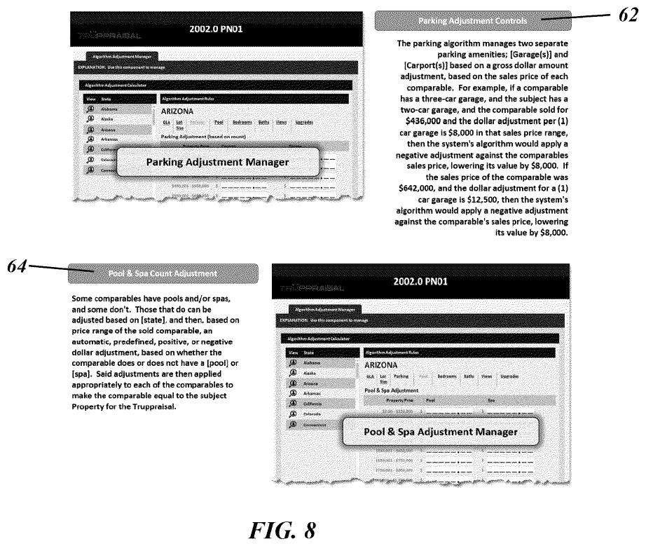

Referring to FIG. 8, at 62 a parking adjustment control (“PAC”) can allow the administrator to set the number of garages or carports. The number car garage or carport can be based on the gross dollar amount adjustment which can be based on the sale price of each comparable home. For example, if a comparable home has a three=car garage, and the comparable home sold for $436,000 and the dollar adjustment per car garage is $8,000 in that sales price range, then the application can apply a negative adjustment against the comparable home's sale price, lowering its value by $8,000. If the sales price of the comparable home was $642,000 and the dollar adjustment for a one car garage is $12,5000, the application can apply a negative adjustment against the comparable home sales price, lowering the value by $8,000.

At 64, pool and spa count adjustment can allow the administrator to set the whether the home comparable has a pool and/or a spa. The home comparable can be adjusted based on the state the home comparable is located in, the price range of the sold comparable home. The adjustment is made either automatically, predefined, positive, or negative dollar amount which can be based on the whether the comparable home does or does not have a pool or spa. Each of the adjustment are then applied to the comparable home to make the comparable home equal to the subject home.

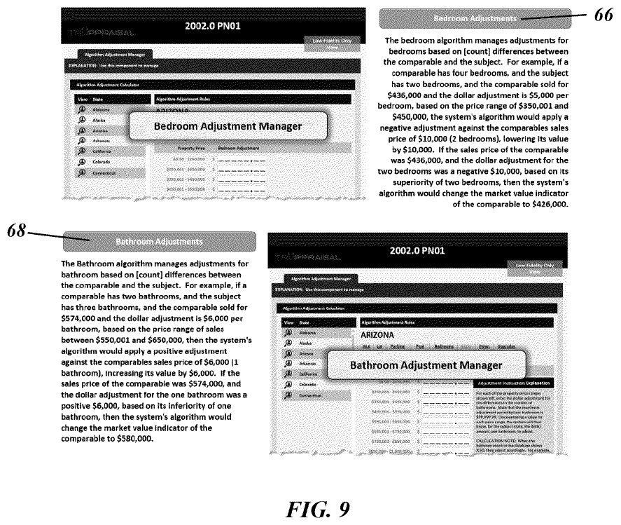

Referring to FIG. 9, the administrator can update a bedroom adjustment. The bedroom adjustment allows adjustments to be made on the bedrooms bases on the differences between the comparable home and the subject home. For example, if a comparable home has four bedrooms, and the comparable home sold for $436 and the dollar adjustment is $5000 per bedroom, based on the price range of $350001 and $450000 the application can apply a negative adjustment against the comparable home sale price of $10,000 (2 bedrooms), lowering its value by $10,0000. If the sale price of the comparable home was $436,000, and the dollar adjustment for the two bedroom was a negative $10,000, based on its superiority of two bedrooms, then the application would change the market value indicator of the comparable home to $426,000.

At 68, the administrator can update a bathroom adjustment. The bathroom adjustment can manage the number of bathrooms and the difference between the comparable homes and the subject home. For example, if a comparable home has two bathrooms, and the comparable home sold for $574,000 and the dollar adjustment is $6,000 per bathroom, based on the price range of sales between 550,001 and $650,000, then the application can apply a positive adjustment against the comparable home sales price of $6,0000. If the sale price of the comparable home was $574,000 and the dollar adjustment for the one bathroom can be a positive $6,000, based on its inferiority of one bathroom, then the application can change the market value indicator of the comparable home to $580,000.

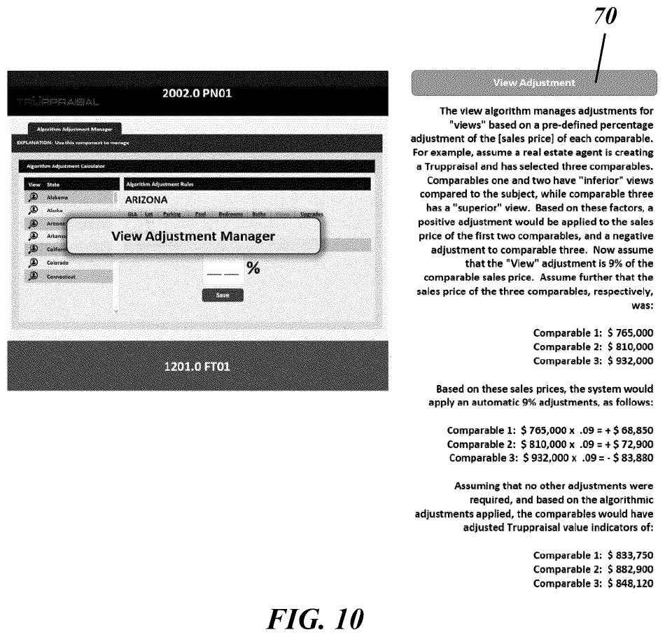

Referring to FIG. 10. the administrator can update a view adjustment. The view adjustment can be made on a pre-defined percentage adjustment of the sales price of each comparable home. For example, an agent can select three comparable homes wherein at least two of the comparable homes has an inferior view to the compared subject home while the third comparable home has a superior view compared to the subject home. Based on the factors, a positive adjustment can be applied to the sale price of the first two comparables, and a negative adjustment to the third comparable home. For example, the view adjustment can be any percentage but in the current example it is 9% of the comparable sales price. Comparable home 1 is $765,000, comparable home 2 is $810,000 and comparable home 3 is $932,000, so based on these sale prices the application will make an automatic 9% adjustment to the sale price and the comparable homes would have an adjusted value of comparable home 1 $844,750, comparable home 2 $882,900 and comparable home 3 $848,120.

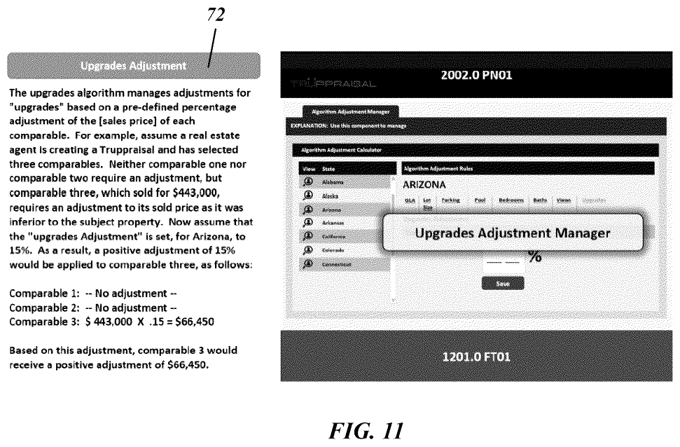

Referring to FIG. 11. the administrator can update an upgrade adjustment. The upgrade adjustment can be based upon a pre-defined percentage of each of the comparable home sale's price. For example, comparable home one and comparable home two do not require any adjustments but comparable home three, which sold for $443,000 requires an adjustment to its sold price as it was inferior to the subject home. The upgrade adjustment can be any set percentage but for this example it is set at fifteen percent and as a result a positive adjustment of fifteen percent would be applied to the comparable home such as, comparable home one needs no adjustment, comparable home two needs no adjustment and comparable home three would be $443,000×0.14=$66,450 positive adjustment.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.we

What is claimed is:

1. A method for improving accuracy of valuations of a subject home having a plurality of home features, wherein the subject home is in a home valuation area that is identified by an address, the method comprising:
providing a platform comprising at least one user account associated with a user profile of the user;
creating a listing of value features that affect the value of a subject home;
accessing data concerning the value features from at least one available database;
identifying the subject home based on input from the user and defining a subject home valuation area;
searching homes within the subject home valuation area and returning a listing of comparable homes to the subject home based at least in part on the associated value features; and
providing a comparable selection guide that allows the user to associate appropriate value features with the comparable homes.

2. The method according to claim 1 further comprising assigning a base value and a value feature value for the subject home and the comparable homes.

3. The method according to claim 1 further comprising adjusting the home valuation area to encompass a desired number of comparable homes.

4. The method according to claim 2 further comprising allowing the user to adjust the value feature value of at least one of the subject home and the comparable homes.

5. The method according to claim 1 wherein the at least one available database accesses data from MLS, Google Map, and/or tax database.

6. The method according to claim 1 wherein the value features are gross living area, lot size, parking, pool, number of bedrooms, number of bathrooms, views, and upgrades done to the comparable home or subject home.

7. The method according to claim 6 wherein the value features are adjusted to fit the market, according to the comparable home or subject home.

8. The method according to claim 7 wherein the agent can accept or reject the adjustment made to the subject home.

9. The method according to claim 8 wherein a report can be generate showing the adjusted value of the subject home.

10. The method according to claim 8 wherein providing the comparable selection guide further comprises providing recommendations based on historical valuation data and market trends within the subject home valuation area.

11. The method according to claim 1 further comprising generating a valuation report for the subject home based on the comparison with the comparable homes.

12. The method according to claim 11 wherein the valuation report includes an estimated value range for the subject home based on the values of the comparable homes.

13. The method according to claim 10 wherein the comparable selection guide comprises a graphical user interface displaying a side-by-side comparison of the subject home and the comparable homes based on value features.

14. The method according to claim 1 wherein the method can further comprise an administrator interface wherein the administrator interface has an adjustment manager wherein the value features or adjustments are updated based on the market conditions.

15. The method according to claim 14 can set a lot size adjustment (“LSA”) wherein every subject home and comparable home has a lot size which is calculated by length times width of the lot.

16. The method according to claim 15 the adjustment manager allows the administrator to control the value features or adjustment in the comparable homes wherein the adjustments are parking control adjustments, gross living area adjustment, spa and pool adjustments, bedroom adjustments, bathroom adjustment, view adjustment, and upgrades adjustment.
